(19) United States
(12) Patent Application Publication
(10) Pub. No.: US 2017/0030865 A1
(43) Pub. Date: Feb. 2, 2017

(54) DATA PROCESSING METHOD AND APPARATUS FOR RECONSTRUCTING ULTRASONIC IMAGE

(71) Applicant: ALPINION MEDICAL SYSTEMS CO., LTD., Hwaseong-si, Gyeonggi-do (KR)

(72) Inventors: Sun-yeob CHANG, Seoul (KR); Keonho SON, Seongnam-si (KR); Hyunchul CHO, Ansan-si (KR); Young-seop LIM, Seoul (KR)

(73) Assignees: ALPINION MEDICAL SYSTEMS CO., LTD., Hwaseong-si, Gyeonggi-do (KR); ALPINION MEDICAL SYSTEMS CO., LTD., Hwaseong-si, Gyeonggi-do (KR)

(21) Appl. No.: 15/039,614

(22) PCT Filed: Nov. 29, 2013
(86) PCT No.: PCT/KR13/10969

§ 371 Date: May 26, 2016

(30) Foreign Application Priority Data
Nov. 29, 2013 (KR) 10-2013-0146890

(51) Int. Cl. G01N 29/06; G01N 29/44

(52) U.S. Cl. CPC G01N 29/0654; G01N 29/44; G01N 29/0627; G01N 29/0636

(57) ABSTRACT

A method and an apparatus for processing data for an ultrasound image reconstruction are disclosed. In some embodiments, a method and an apparatus for processing data for reconstructing an ultrasound image are provided, which are capable of storing first frame data generated by a focused ultrasound in a realtime display mode and a parameter for the first frame data, and when a specific event is detected as occurring, and additionally storing second frame data generated by an unfocused ultrasound and a parameter for the second frame data, thus expanding the scope of application of the data for an image reconstruction and acquiring various formats of improved ultrasound images.

### TECHNICAL FIELD

Some embodiments of the present disclosure relate to a method and an apparatus for processing data for reconstructing an ultrasound image based on acquired ultrasound data in an ultrasound imaging apparatus.

### BACKGROUND

The statements in this section merely provide background information related to the present disclosure and do not necessarily constitute prior art.

An ultrasound imaging apparatus transmits an ultrasound to a subject by using a probe, receives a reflection signal reflected at the subject, and forms an ultrasound image by converting the reflection signal into an electrical signal.

Such an ultrasound imaging apparatus displays the ultrasound image, and stores data regarding the ultrasound image and a parameter for the data in the process of displaying the ultrasound image. Thereafter, upon receiving a request signal for reconstructing an image from a user, the ultrasound imaging apparatus reconstructs the ultrasound image based on the stored data and parameter. In order for the ultrasound imaging apparatus to acquire improved ultrasound images of various forms, a technology is needed to more expand the scope of application of the data and the parameter stored in the ultrasound imaging apparatus.

### DISCLOSURE

### Technical Problem

It is an object of some embodiments of the present invention to provide a method and an apparatus for processing ultrasound data capable of additionally storing ultrasound data acquired by using an unfocused ultrasound when storing data required to reconstruct an image while an ultrasound imaging apparatus displays a live image by using a focused ultrasound.

### Summary

According to some embodiments of the present invention, a method for acquiring and processing data for an ultrasound image reconstruction in an ultrasound imaging apparatus includes acquiring first ultrasound data generated by a focused ultrasound wave in a realtime display mode, displaying an ultrasound image based on the first ultrasound data, and a second-ultrasound-data storing step including transmitting an unfocused ultrasound to a subject selectively during an operation in the realtime display mode and storing, together with the first ultrasound data, second ultrasound data generated by the unfocused ultrasound.

According to some embodiments of the present invention, an ultrasound imaging apparatus includes a control unit and a storage unit. The control unit is configured to control a transducer to transmit a focused ultrasound to a subject in a realtime display mode, to cause a display of an ultrasound image based on first ultrasound data generated by the focused ultrasound, to control the transducer to transmit an unfocused ultrasound to the subject selectively during an operation in the realtime display mode, and to cause second ultrasound data generated by the unfocused ultrasound to be stored with the first ultrasound data. The storage unit is configured to store the first ultrasound data and the second ultrasound data.

### Advantageous Effects

As described above, according to some embodiments of the present invention, in addition to storing data for image reconstruction in the process of displaying a live image by an ultrasound imaging apparatus based on a focused ultrasound, ultrasound data acquired by using an unfocused ultrasound is stored and thereby the scope of application of the image reconstruction data is expanded to provide a variety of improved ultrasound image formats.

### BRIEF DESCRIPTION OF DRAWINGS

FIG. 1 is a schematic block diagram of an ultrasound imaging apparatus according to some embodiments of the present invention.

FIG. 2A is a schematic diagram illustrating a step of acquiring data for reconstructing an ultrasound image according to some embodiments of the present invention.

FIG. 2B is a schematic diagram illustrating a step of acquiring data for reconstructing an ultrasound image according to some embodiments of the present invention.

FIG. 3 is a schematic diagram illustrating a step of reconstructing an ultrasound image based on data acquired by the ultrasound imaging apparatus according to some embodiments of the present invention.

FIG. 4 is a flowchart of a method for acquiring and processing data for reconstructing an ultrasound image by the ultrasound imaging apparatus according to some embodiments of the present invention.

### DETAILED DESCRIPTION

Exemplary embodiments of the present invention are described in detail below with reference to the accompanying drawings.

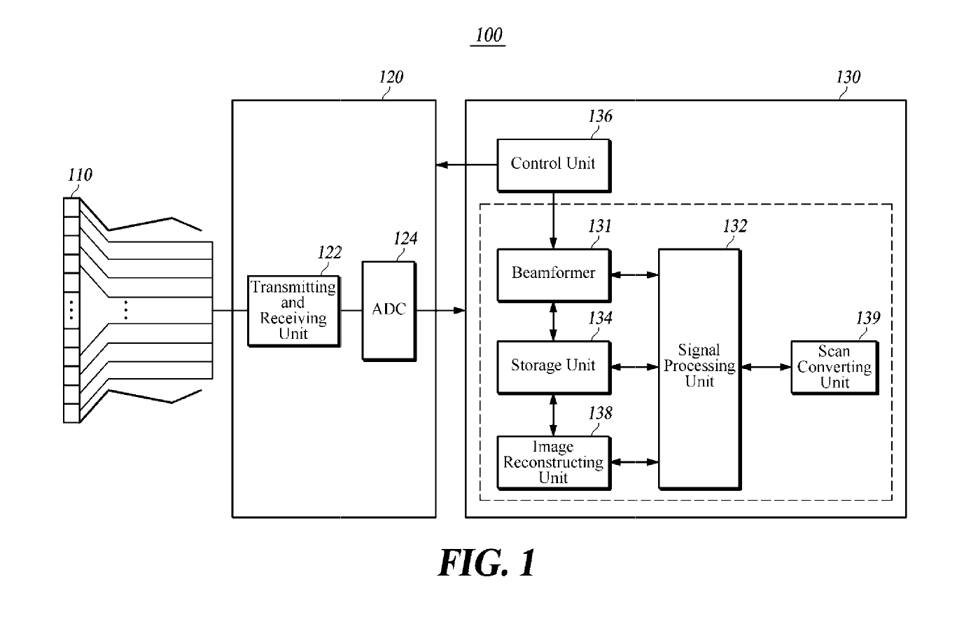

FIG. 1 is a schematic block diagram of an ultrasound imaging apparatus according to some embodiments of the present invention.

As shown in FIG. 1, an ultrasound imaging apparatus 100 according to some embodiments of the present invention is an apparatus for performing a software-based beamforming, and includes a transducer 110, a front-end processing unit 120 and a host 130. In some other embodiments, a part of the blocks can be added, modified, or removed to or from the ultrasound imaging apparatus 100 shown in FIG. 1.

The front-end processing unit 120 includes a transmitting and receiving unit 122 and an analog-to-digital converter 124. The host 130 includes a beamformer 131, a signal processing unit 132, a storage unit 134, a control unit 136, an image reconstructing unit 138, and a scan converting unit 139. The host 130 performs a software-based parallel processing for achieving high-speed image processing. An architecture for the parallel processing may include a multicore central processing unit (CPU) and a graphic processing unit (GPU).

The front-end processing unit 120 and the host 130 are connected to each other via a standard interface for transmitting data, such as a PCI-Express.

The transducer 110 converts an electrical analog signal into an ultrasound, transmits the ultrasound to a subject, and converts a signal reflected at the subject (hereinafter, a “reflection signal”) into an electrical analog signal. When the transducer 110 includes a transducer array, the transducer 110 transmits the ultrasound to the subject by using a plurality of elements of the transducer array and receives the reflection signal from the subject. The transducer 110 transmits the reflection signal received from the subject to the host 130.

The transducer 110 according to some embodiments of the present invention transmits a focused ultrasound to the subject under the control of the transmitting and receiving unit 122 in a realtime display mode, and then receives a first reflection signal corresponding to the focused ultrasound from the subject. The realtime display mode refers to a mode of displaying a live ultrasound image in realtime based on the ultrasound transmitted to the subject. The transducer 110 further transmits an unfocused ultrasound to the subject selectively while operating in the realtime display mode, and then receives a second reflection signal corresponding to the unfocused ultrasound from the subject. The unfocused ultrasound includes at least one of a plane wave or a broad beam. The second reflection signal can be subjected to a software-based high-speed image processing.

The transducer 110 transmits the focused ultrasound to the subject under the control of the transmitting and receiving unit 122 for a first transmission and reception interval, and selectively transmits the unfocused ultrasound to the subject at least once for a second transmission and reception interval. The first transmission and reception interval and the second transmission and reception interval have different transmitting and receiving timings from each other. An operation of the transducer 110 under the control of the transmitting and receiving unit 122 is as follows. Firstly, the transducer 110 transmits the focused ultrasound to the subject along a scanline for the first transmission and reception interval. In addition, the ultrasound imaging apparatus 100 selectively transmits the unfocused ultrasound to the subject at least once by using all of the scanlines for the second transmission and reception interval.

The unfocused ultrasound transmitted to the subject by the transducer 110 may have a frequency that differs from a frequency of the focused ultrasound or a phase that differs from a phase of the focused ultrasound. Further, the transducer 110 may transmit the unfocused ultrasound a plurality of times for the second transmission and reception interval. At this time, the transducer 110 may transmit the unfocused ultrasound with a predetermined phase difference to the subject. In some embodiments, the focused ultrasound and the unfocused ultrasound outputted from the transducer 110 are not limited to specific forms.

Constituent elements of the front-end processing unit 120 are described below.

The transmitting and receiving unit 122 applies a pulsed voltage to the transducer 110 to cause each transducer element of the transducer 110 to output the focused ultrasound or the unfocused ultrasound. Further, the transmitting and receiving unit 122 performs a function of switching transmission and reception to allow the transducer 110 to perform a transmission and a reception of the ultrasound in an alternate manner.

The transmitting and receiving unit 122 according to some embodiments of the present invention controls the transducer 110 based on a control instruction received from the control unit 136 to allow the focused ultrasound to be transmitted to the subject for the first transmission and reception interval. Further, upon detection of an occurrence of a specific event, the transmitting and receiving unit 122 controls the transducer 110 based on the control instruction received from the control unit 136 to allow the unfocused ultrasound to be selectively transmitted at least once for the second transmission and reception interval. Moreover, the transmitting and receiving unit 122 operates to interleave the second transmission and reception intervals with first transmission and reception intervals. The specific event occurs when, for example, an instruction for acquiring additional image reconstruction data is received from a user. In some embodiments, the specific event occurs when the user stops displaying the image.

The analog-to-digital converter 124 converts the analog reflection signal received from the transmitting and receiving unit 122 into a digital signal, and outputs the digital signal.

When the analog reflection signal received from the transmitting and receiving unit 122 is the first reflection signal corresponding to the focused ultrasound, the analog-to-digital converter 124 according to some embodiments of the present invention converts the analog reflection signal into a digital signal, and then transmits the digital signal to the beamformer 131. When the analog reflection signal received from the transmitting and receiving unit 122 is the second reflection signal corresponding to the unfocused ultrasound, the analog-to-digital converter 124 according to some embodiments of the present invention converts the analog reflection signal into a digital signal, and then transmits the digital signal to the storage unit 134.

Constituent elements of the host 130 are described below.

The beamformer 131 delays an electrical signal appropriate for the transducer 110, and obtains an electrical signal that fits each transducer element. Further, the beamformer 131 calculates an output value of a transducer element by delaying or summing electrical signals converted at respective corresponding transducer elements. The beamformer 131 includes a transmit beamformer, a receive beamformer and a beamforming unit. The beamformer 131 can be connected to the analog-to-digital converter 124 and the signal processing unit 132 via a full parallel path for performing a software-based high-speed image processing.

The beamformer 131 according to some embodiments of the present invention receives the first reflection signal, and allows first frame data to be generated based on the first reflection signal. For example, when receiving the first reflection signal, the beamformer 131 performs a beamforming on the first reflection signal, and generates the first frame data therethrough. Thereafter, the beamformer 131 transmits the first frame data to the signal processing unit 132.

The signal processing unit 132 converts a reflection signal of a receive scanline focused at the beamformer 131 into a baseband signal, and obtains data for a scanline by detecting an envelope by using a quadrature demodulator. Further, the signal processing unit 132 processes the data generated by the beamformer 131 into a digital signal. Moreover, the signal processing unit 132 post-processes the first frame data after receiving the same from the beamformer 131, thus enabling the ultrasound image based on the focused ultrasound to be displayed in realtime in the realtime display mode.

The storage unit 134 stores first ultrasound data including the first frame data generated by the focused ultrasound based on the control instruction from the control unit 136 and a first parameter for the first frame data, and stores, together with the first ultrasound data, second ultrasound data including second frame data generated by the unfocused ultrasound and a second parameter for the second frame data. Thereafter, when an input signal for reconstructing an image is received, the storage unit 134 provides the first ultrasound data and the second ultrasound data stored therein, as a parameter for reconstructing an ultrasound image. Although it is described that the storage unit 134 stores the first ultrasound data generated based on the focused ultrasound in some embodiments, in some other embodiments, a storage means for storing the first ultrasound is separately provided. The storage unit 134 can expand the scope of application of the ultrasound image reconstruction data by additionally storing the second ultrasound data generated by the unfocused ultrasound as well as the first ultrasound generated by the focused ultrasound based on the control instruction from the control unit 136. When the ultrasound image is reconstructed by using the image reconstructing unit 138, the storage unit 134 is further provided with and stores a reconstructed ultrasound image and parameter information applied in a process of reconstructing the ultrasound image, to allow improved ultrasound images of various forms to be reconstructed later on.

The storage unit 134 according to some embodiments of the present invention includes a first memory and a second memory. The first memory includes a volatile memory, e.g., a random access memory (RAM), and the second memory includes a nonvolatile memory, e.g., a hard disk drive (HDD). The first ultrasound data generated by the focused ultrasound in the realtime display mode are stored in the first memory, and can be used in a cine process of reconstructing the ultrasound image. The storage unit 134 may additionally store the second ultrasound data generated by the unfocused ultrasound as well as the first ultrasound data generated by the focused ultrasound in the realtime display mode based on the control instruction from the control unit 136. At this time, the first ultrasound data and the second ultrasound data are stored in the second memory, and can be used in a virtual rescan process of reconstructing the ultrasound image. However, the present invention is not limited to this scheme, but the first ultrasound data and the second ultrasound data can be alternatively stored in the first memory, and can be used in the cine process of reconstructing the ultrasound image.

The control unit 136 performs an overall management of the front-end processing unit 120 and the host 130. The control unit 136 controls the transmitting and receiving unit 122 to allow the transducer 110 to transmit the focused ultrasound to the subject for the first transmission and reception interval in the realtime display mode. Thereafter, the control unit 136 allows a realtime display of the ultrasound image based on the first ultrasound data generated by the focused ultrasound. For example, the control unit 136 controls the beamformer 131 to perform a beamforming for the first frame data based on input information on a parameter inputted by a user and predetermined parameter setting information, through which allowing the first frame data to be displayed in realtime. Thereafter, the control unit 136 allows the first ultrasound data including the first frame data and the first parameter for the first frame data to be stored in the storage unit 134. It is preferred that the first frame data stored in the storage unit 134 by the control unit 136 be frame data that is after the beamforming performed by the beamformer 131 but right before being finally displayed to the user; however, the present invention is not limited to this scheme. Further, it is preferred that the first parameter be information on a parameter that is applied to the first frame data in a process of finally displaying the first frame data to the user; however, the present invention is not limited to this scheme. For example, in some embodiments, the first parameter further includes information on parameters applied until the first frame data are formed from the first reflection signal as well as the information on the parameter applied to the first frame data in the process of finally displaying the first frame data to the user.

Further, the control unit 136 controls the transmitting and receiving unit 122 to cause the transducer 110 to selectively transmit the unfocused ultrasound to the subject while operating in the realtime display mode, and to cause the second ultrasound data including the second frame data generated by the unfocused ultrasound and the second parameter of the second frame data to be stored in the storage unit 134 together with the first ultrasound data. At this time, the second frame data stored in the storage unit 134 by way of the control unit 136 refers to frame data before undergoing a beamforming or, for example, the second reflection signal converted into the digital signal by the analog-to-digital converter 124. The second parameter refers to information on parameters applied up to forming the converted digital signal from the second reflection signal. When a specific event is detected as occurring while in the realtime display mode of operation, the control unit 136 according to some embodiments of the present invention controls the transmitting and receiving unit 122 to cause the transducer 110 to transmit the focused ultrasound to the subject for the first transmission and reception interval and to transmit the unfocused ultrasound to the subject at least once for the second transmission and reception interval. Further, the control unit 136 causes the first ultrasound data corresponding to the focused ultrasound to be stored in the storage unit 134 in a continuous manner. When a detection of a specific event causes the transducer 110 to transmit the unfocused ultrasound to the subject, the control unit 136 allows the second ultrasound data corresponding to the unfocused ultrasound to be additionally stored together with the first ultrasound data. Although it is described that the control unit 136 operates to store the first ultrasound data, and is responsive to a detection of a specific event for operating to additionally store the second ultrasound data in some embodiments, the present invention is not limited to this scheme. In some other embodiments, a detection of a specific event occurring may cause the first ultrasound data and the second ultrasound data to be stored in a simultaneous manner.

Upon receiving an input signal for reconstructing an image from the user, the image reconstructing unit 138 performs an overall operation for reconstructing the ultrasound image by using the first ultrasound data and the second ultrasound data stored in the storage unit 134. When an image reconstructing signal input is received from the user, the image reconstructing unit 138 provides an interface for manipulating an image modality or a parameter. Thereafter, the image reconstructing unit 138 is responsive to input information on a specific image modality or a specific parameter received through the interface from the user for performing an ultrasound image reconstruction.

In a preceding process, the image reconstructing unit 138 may have determined and stored, in the storage unit 134, informations on such image modalities that would be applicable to reconstructing an ultrasound image based on the first ultrasound data and the second ultrasound data and on parameter setting values for realizing the corresponding image modalities, so that the image reconstructing unit 138 renders the corresponding information to be displayed on the interface when receiving an image reconstructing signal input. At this time, the applicable image modalities provided through the interface include at least one of a frequency compounding (FRCD), a spatial compounding (SPCD), or a tissue harmonic imaging (THI); however, the present invention is not limited to this scheme. When a specific image modality is selected through the interface, the image reconstructing unit 138 determines a setting value of a parameter that matches the specific image modality, and operates to cause the ultrasound image to be reconstructed reflecting the determined setting value of the parameter on the first ultrasound data and the second ultrasound data.

The following describes an operation of the image reconstructing unit 138 to allow the ultrasound image to be reconstructed based on the first ultrasound data and the second ultrasound data stored in the storage unit 134. In some embodiments, upon receiving an image reconstructing signal input, the image reconstructing unit 138 according to some embodiments of the present invention reconstructs the image by using all the first ultrasound data and the second ultrasound data stored in the storage unit 134. For example, the image reconstructing unit 138 performs a beamforming for the second frame data based on information on the parameters applied up to generating the first frame data from the first reflection signal among first parameters stored in the storage unit 134, and reconstructs the image by combining the second frame data that underwent the beamforming with the first frame data. This enables the image reconstructing unit 138 to acquire an ultrasound image with improved quality over a conventional ultrasound image.

The image reconstructing unit 138 performs a beamforming on each of the second frame data generated by unfocused ultrasounds transmitted a plurality of times in different directions, and a reconstructing of an image based on the second frame data after the beamforming and the first frame data, thus generating a spatial compound image. Further, in some embodiments, the image reconstructing unit 138 performs a beamforming on the second frame data generated by the unfocused ultrasound having a frequency different from that of the focused ultrasound, and generates a frequency compound image by reconstructing an image based on the second frame data after the beamforming and the first frame data. In some embodiments, the image reconstructing unit 138 reconstructs an image by using all of the first ultrasound data and the second ultrasound data, and in some embodiments, the image reconstructing unit 138 reconstructs an image by using either one of the first ultrasound data and the second ultrasound data.

For example, upon receiving an image reconstructing signal input, the image reconstructing unit 138 according to some embodiments of the present invention performs a virtual rescan process of reconstructing an ultrasound image by using the second ultrasound data stored in the storage unit 134. For example, the image reconstructing unit 138 can reconstruct an ultrasound image by applying various image modalities and image processing techniques on the second frame data before a beamforming process, thus achieving improved ultrasound images of various forms.

When receiving an image reconstructing signal input, the image reconstructing unit 138 provides an interface for manipulating an image modality or a parameter. Thereafter, the image reconstructing unit 138 allows a specific parameter to be applied to the second frame data based on input information on an image modality or a parameter inputted from the interface, and finally operates the beamformer 131 to perform a beamforming on the second frame data based on the specific parameter, thus reconstructing an ultrasound image.

Further, in response to an image reconstructing signal input received, the image reconstructing unit 138 performs a cine process of reconstructing an ultrasound image by using the first ultrasound data stored in the storage unit 134. For example, the image reconstructing unit 138 reconstructs the ultrasound image by applying various image modalities and image processing techniques to the first frame data that underwent the beamforming, thus achieving improved ultrasound images of various forms. When receiving an image reconstructing signal input, the image reconstructing unit 138 performs a review process on the first frame data and the first parameter, and provides an interface for manipulating an image modality or a parameter. Thereafter, the image reconstructing unit 138 allows a specific parameter to be applied to the first frame data based on input information on an image modality or a parameter inputted from the interface, and allows the first frame data applied with the specific parameter to be eventually displayed via the signal processing unit 132.

The scan converting unit 139 aligns a scan direction of data obtained by the beamformer 131 with a pixel direction of a display unit (e.g., a monitor), and maps the data to a pixel position of the display unit. The image reconstructing unit 138 converts a data format of the ultrasound image data into a data format that is used in the display unit having a predetermined scanline display format.

The ultrasound imaging apparatus 100 further includes a user input unit that receives an instruction by a manipulation or an input by a user. A user instruction can be, for example, a setting instruction for controlling the ultrasound imaging apparatus 100.

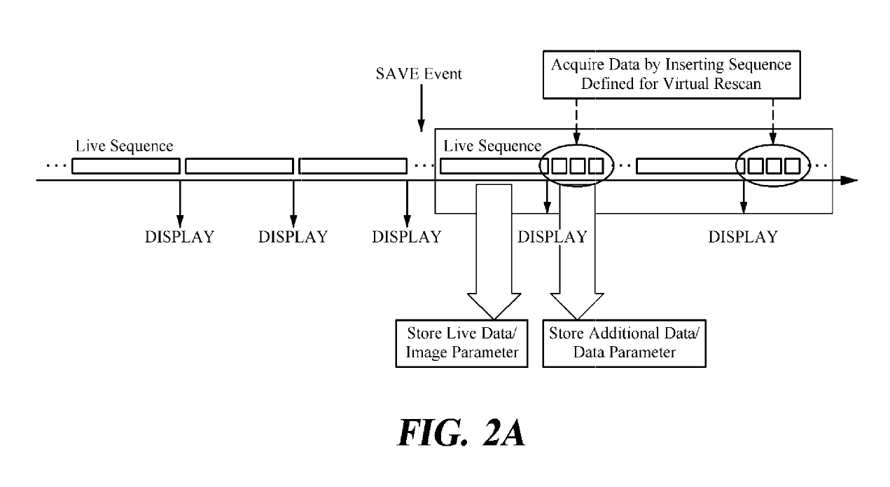

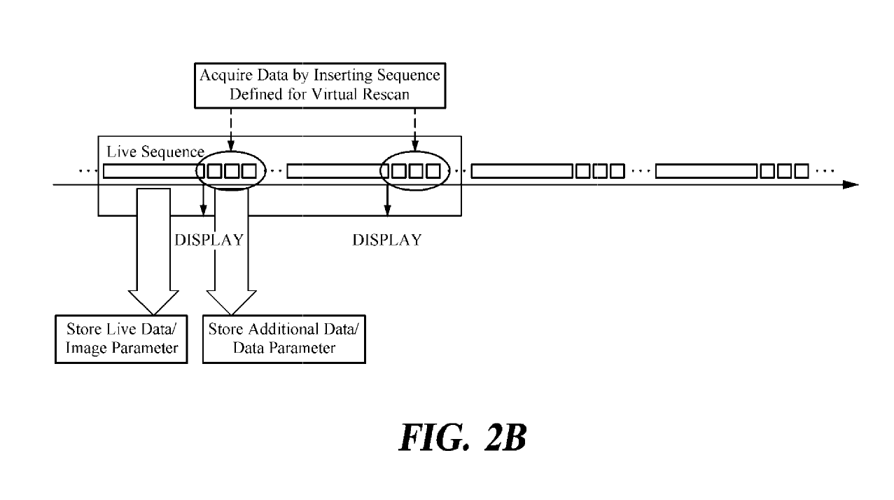

FIG. 2A is a schematic diagram illustrating a step of acquiring data for reconstructing an ultrasound image according to some embodiments of the present invention. In FIG. 2A, the first frame data generated by the focused ultrasound are referred to as Live data, the first parameter for the first frame data is referred to as an image parameter, the second frame data generated by the unfocused ultrasound are referred to as additional data, and the second parameter for the second frame data is referred to as a data parameter.

As shown in FIG. 2A, the ultrasound imaging apparatus 100 according to some embodiments of the present invention transmits the focused ultrasound to the subject for the first transmission and reception interval in the realtime display mode, and performs a beamforming process by receiving the first reflection signal corresponding to the focused ultrasound from the subject, thus generating the first frame data. Thereafter, the ultrasound imaging apparatus 100 applies a specific parameter to the first frame data based on input information on a parameter inputted by the user and predetermined parameter setting information, and allows a realtime display of the first frame data applied with the specific parameter. Although the first frame data are referred to as a Live sequence in FIG. 2A, this is merely an example for describing that the first frame data can be implemented with frame data composed of a Live sequence formed for each scanline or a plurality of Live sequences; and therefore, the first frame data can be substantially implemented in a frame data form including the Live sequence or a plurality of Live sequences. Thereafter, the ultrasound imaging apparatus 100 stores the first ultrasound data including the first frame data generated by the focused ultrasound and the first parameter for the first frame data.

In FIG. 2A, the ultrasound imaging apparatus 100 continuously stores the first ultrasound data generated by the focused ultrasound, and when a generation of a specific event is detected, allows the transducer 110 to transmit the unfocused ultrasound at least once more for the second transmission and reception interval, and operates to store, together with the first ultrasound data, the second ultrasound data including the second frame data generated by the unfocused ultrasound and the second parameter for the second frame data. Thereafter, when an image reconstructing signal input is received from the user, the ultrasound imaging apparatus 100 reconstructs the ultrasound image based on the stored first ultrasound data and the stored second ultrasound data. For example, the ultrasound imaging apparatus 100 generates a spatial compound image and a frequency compound image by reconstructing an image by using all the first ultrasound data and the second ultrasound data. Further, the ultrasound imaging apparatus 100 reconstructs the ultrasound image by performing a virtual rescan process by using the second ultrasound data or performing a cine process by using the first ultrasound data. A process, performed by the ultrasound imaging apparatus 100, for reconstructing an image by using the first ultrasound data and the second ultrasound data is similar to that shown in FIG. 1, and therefore a detailed description thereof is omitted.

FIG. 2B is a schematic diagram illustrating a step of acquiring data for reconstructing an ultrasound image according to another embodiment of the present invention. In FIG. 2B, the first frame data generated by the focused ultrasound are referred to as LIVE data, the first parameter for the first frame data is referred to as an image parameter, the second frame data generated by the unfocused ultrasound are referred to as additional data, and the second parameter for the second frame data is referred to as a data parameter.

As shown in FIG. 2B, the ultrasound imaging apparatus 100 operates to transmit the focused ultrasound for the first transmission and reception interval, and to transmit the unfocused ultrasound at least once for the second transmission and reception interval. Thereafter, the ultrasound imaging apparatus 100 operates to display the first frame data generated by the focused ultrasound in realtime, to store the first ultrasound data including the first frame data and the first parameter for the first frame data, and to store, together with the first ultrasound data, the second ultrasound data including the second frame data generated by the unfocused ultrasound and the second parameter for the second frame data in realtime. For example, in FIG. 2B, the ultrasound imaging apparatus 100 operates to transmit the focused ultrasound and the unfocused ultrasound to the subject in realtime regardless of a detection of an occurrence of a specific event, and to store in real time all of the first ultrasound data and the second ultrasound data thus acquired.

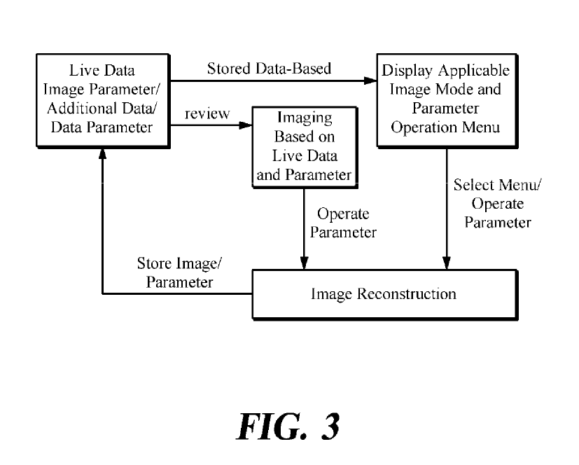

FIG. 3 is a schematic diagram illustrating a step of reconstructing an ultrasound image based on data acquired by the ultrasound imaging apparatus 100 according to some embodiments of the present invention. In FIG. 3, the first frame data generated by the focused ultrasound are referred to as LIVE data, the first parameter for the first frame data is referred to as an image parameter, the second frame data generated by the unfocused ultrasound are referred to as additional data, and the second parameter for the second frame data is referred to as a data parameter.

As shown in FIG. 3, the ultrasound imaging apparatus 100 according to some embodiments of the present invention stores the first ultrasound data including the first frame data generated by the focused ultrasound and the first parameter for the first frame data, and additionally stores, together with the first ultrasound data, the second ultrasound data including the second frame data generated by the unfocused ultrasound and the second parameter for the second frame data. Thereafter, when an image reconstructing signal input is received from the user, the ultrasound imaging apparatus 100 reconstructs the ultrasound image by using the stored first ultrasound data and the stored second ultrasound data.

The ultrasound imaging apparatus 100 according to some embodiments of the present invention generates a spatial compound image and a frequency compound image by reconstructing an image by using all the first ultrasound data and the second ultrasound data. Further, the ultrasound imaging apparatus 100 reconstructs the ultrasound image by performing a virtual rescan process by using the second ultrasound data or performing a cine process by using the first ultrasound data. A process, performed by the ultrasound imaging apparatus 100, for reconstructing an image by using the first ultrasound data and the second ultrasound data is similar to that shown in FIG. 1, and therefore a detailed description thereof is omitted.

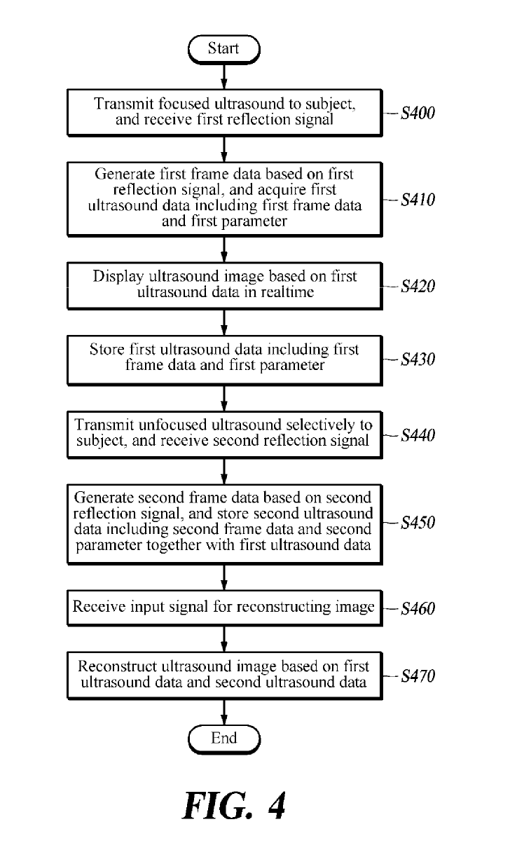

FIG. 4 is a flowchart of a method for acquiring and processing ultrasound image reconstructing data by the ultrasound imaging apparatus 100 according to some embodiments of the present invention.

The ultrasound imaging apparatus 100 allows the focused ultrasound to be transmitted to the subject in the realtime display mode, and receives the first reflection signal reflected at the subject (Step S400). In Step S400, the ultrasound imaging apparatus 100 transmits the focused ultrasound to the subject along a transmission scanline by appropriately delaying input times for pulses inputted to the respective transducer elements, and receives the first reflection signals reflected at the subject, corresponding to the focused ultrasound.

The ultrasound imaging apparatus 100 generates the first frame data based on the first reflection signals received in Step S400, and acquires the first ultrasound data including the first frame data and the first parameter for the first frame data (Step S410). Thereafter, the ultrasound imaging apparatus 100 displays the ultrasound image based on the first ultrasound data (Step S420). When receiving the first reflection signals, the ultrasound imaging apparatus 100 performs a beamforming process on the first reflection signals to generate the first frame data. Thereafter, the ultrasound imaging apparatus 100 applies a specific parameter on the first frame data based on input information on a parameter inputted by the user and predetermined parameter setting information, and thereby allows a realtime display of first frame data applied with the specific parameter. In this step, the ultrasound imaging apparatus 100 acquires the first ultrasound data including the first frame data and the first parameter for the first frame data.

The ultrasound imaging apparatus 100 stores the first ultrasound data including the first frame data and the first parameter for the first frame data (Step S430). The first frame data stored in Step S430 are the first frame data generated by performing a beamforming in Step S410, and the first parameter includes information on a parameter applied to the first frame data in a process of finally displaying the first frame data to the user.

The ultrasound imaging apparatus 100 selectively transmits the unfocused ultrasound to the subject while operating in the realtime display mode, and receives the second reflection signals reflected at the subject (Step S440). In Step S440, when detecting a specific event occurred while operating in the realtime display mode, the ultrasound imaging apparatus 100 allows the unfocused ultrasound to be transmitted to the subject. For example, the ultrasound imaging apparatus 100 transmits the focused ultrasound for the first transmission and reception interval, and when a specific event is detected as occurred, transmits the unfocused ultrasound at least once for the second transmission and reception interval. The specific event occurs when an instruction for acquiring additional data for reconstructing an ultrasound image is received from the user. In some embodiments, the specific event occurs when the user stops displaying an image.

The ultrasound imaging apparatus 100 generates the second frame data by using the second reflection signals received in Step S440, and stores, together with the first ultrasound data, the second ultrasound data including the second frame data and the second parameter for the second frame data (Step S450). In Step S450, when detecting a specific event occurred, the ultrasound imaging apparatus 100 additionally stores, together with the first ultrasound data, the second ultrasound data including the second frame data generated by the unfocused ultrasound transmitted to the subject and the second parameter for the second frame data. At this time, the second frame data are frame data before undergoing a beamforming, e.g., the second reflection signal through the digital conversion by the analog-to-digital converter 124, and the second parameter refers to information on parameters applied up to the generation of the digitally converted second reflection signal.

When receiving an input signal for reconstructing an image (Step S460), the ultrasound imaging apparatus 100 reconstructs the ultrasound image by using the stored first ultrasound data and the stored second ultrasound data in the ultrasound imaging apparatus 100 (Step S470). In Step S470, when an image reconstructing signal input is received, the ultrasound imaging apparatus 100 provides an interface for manipulating an image modality or a parameter. Thereafter, when input information on a specific image modality and a specific parameter is received from the user through the interface, the ultrasound imaging apparatus 100 applies that information to the stored first ultrasound data and the stored second ultrasound data, thereby reconstructing the ultrasound image. For example, the ultrasound imaging apparatus 100 generates a spatial compound image and a frequency compound image by reconstructing an image by using all the first ultrasound data and the second ultrasound data. Further, the ultrasound imaging apparatus 100 reconstructs the ultrasound image by performing a virtual rescan process by using the second ultrasound data or performing a cine process by using the first ultrasound data. A process, performed by the ultrasound imaging apparatus 100, for reconstructing an image by using the first ultrasound data and the second ultrasound data is similar to that shown in FIG. 1, and therefore a detailed description thereof is omitted.

Although it is described that Steps S400 to S470 are sequentially performed in FIG. 4, the present invention is not limited to this scheme. One can modify the steps described in FIG. 4 or to perform two or more steps in parallel, and hence the steps described in FIG. 4 are not limited to the chronological order.

The method of acquiring and processing the data for reconstructing the ultrasound image by the ultrasound imaging apparatus according to some embodiments shown in FIG. 4 can be implemented as a program and stored in a computer-readable recording medium. The computer-readable recording medium for storing the program implementing the method of acquiring and processing the data for reconstructing the ultrasound image by the ultrasound imaging apparatus according to some embodiments includes all kinds of recording device for storing data that can be read by a computer system.

Although exemplary embodiments of the present disclosure have been described for illustrative purposes, those skilled in the art will appreciate that various modifications, additions and substitutions are possible, without departing from the idea and scope of the claimed invention. Specific terms used in this disclosure and drawings are used for illustrative purposes and not to be considered as limitations of the present disclosure. Therefore, exemplary embodiments of the present disclosure have been described for the sake of brevity and clarity. Accordingly, one of ordinary skill would understand the scope of the claimed invention is not to be limited by the explicitly described above embodiments but by the claims and equivalents thereof.

### CROSS-REFERENCE TO RELATED APPLICATION

This application claims priority under 35 USC §119(a) of Patent Application No. 10-2013-0146890, filed on Nov. 29, 2013 in Korea, the entire content of which is incorporated herein by reference. In addition, this non-provisional application claims priority in countries, other than the U.S., with the same reason based on the Korean patent application, the entire content of which is hereby incorporated by reference.

1. A method for acquiring and processing data for an ultrasound image reconstruction in an ultrasound imaging apparatus, the method comprising:
acquiring first ultrasound data generated by a focused ultrasound in a realtime display mode;
displaying an ultrasound image based on the first ultrasound data; and
storing, together with the first ultrasound data, second ultrasound data generated by an unfocused ultrasound selectively transmitted to a subject during an operation in the realtime display mode.

2. The method of claim 1, wherein the acquiring of the first ultrasound data comprises:
transmitting the focused ultrasound to the subject and receiving one or more first reflection signals reflected at the subject, and
generating first frame data based on the first reflection signals and acquiring the first ultrasound data including the first frame data and a first parameter for the first frame data.

3. The method of claim 2, wherein the storing of the second ultrasound data comprises:
transmitting the unfocused ultrasound to the subject selectively during the operation in the realtime display mode,
receiving one or more second reflection signals corresponding to the unfocused ultrasound from the subject, and
generating second frame data based on the second reflection signals and storing, together with the first ultrasound data, the second frame data and a second parameter for the second frame data.

4. The method of claim 3, wherein the unfocused ultrasound is transmitted to the subject, when a specific event is detected.

5. The method of claim 3, wherein
the first frame data comprise frame data that underwent a beamforming, and
the second frame data comprise frame data before a beamforming process.

6. The method of claim 1, wherein the unfocused ultrasound has a frequency that differs from a frequency of the focused ultrasound or a phase that differs from a phase of the focused ultrasound.

7. The method of claim 1, wherein the unfocused ultrasound is transmitted a plurality of times with different transmission angles.

8. The method of claim 1, further comprising:
receiving an input signal for an image reconstruction; and
reconstructing the ultrasound image based on the first ultrasound data and the second ultrasound data.

9. The method of claim 8, further comprising providing, when the input signal is received, an interface for manipulating an image mode or a parameter, wherein
the reconstructing of the ultrasound image comprises reconstructing the ultrasound image based on an input information on the image mode or the parameter inputted from the interface.

10. An ultrasound imaging apparatus, comprising:
a control unit configured to
control a transducer to transmit a focused ultrasound to a subject in a realtime display mode,
cause a display of an ultrasound image based on first ultrasound data generated by the focused ultrasound,
control the transducer to transmit an unfocused ultrasound to the subject selectively during an operation in the realtime display mode, and
cause second ultrasound data generated by the unfocused ultrasound to be stored with the first ultrasound data; and
a storage unit configured to store the first ultrasound data and the second ultrasound data.

11. The ultrasound imaging apparatus of claim 10, wherein the control unit is configured, when a specific event is detected, to control the transducer to transmit the unfocused ultrasound to the subject.

12. The ultrasound imaging apparatus of claim 10, wherein the unfocused ultrasound has a frequency that differs from a frequency of the focused ultrasound or a phase that differs from a phase of the focused ultrasound.

13. The ultrasound imaging apparatus of claim 10, wherein the unfocused ultrasound is transmitted a plurality of times with different transmission angles.

14. The ultrasound imaging apparatus of claim 10, further comprising an image reconstructing unit configured, when receiving an input signal for an image reconstruction, to operate to reconstruct the ultrasound image based on the first ultrasound data and the second ultrasound data.

15. The ultrasound imaging apparatus of claim 14, wherein the image reconstructing unit is configured to be responsive to the input signal received for providing an interface for manipulating an image modality or a parameter and to operate to reconstruct the ultrasound image based on an input information on a manipulation of the image modality or the parameter inputted through the interface.
